(19) United States
(12) Patent Application Publication
(10) Pub. No.: US 2008/0260078 A1
(43) Pub. Date: Oct. 23, 2008

(54) Iterative Reception of a Multi-Carrier Signal With Interference Cancellation

(76) Inventors: Pierre-Jean Bouvet, Caen (FR); Maryline Helard, Rennes (FR)

Correspondence Address: WESTMAN CHAMPLIN & KELLY, P.A., SUITE 1400, 900 SECOND AVENUE SOUTH, MINNEAPOLIS, MN, 55402-3244, US

(21) Appl. No.: 11/908,085

(22) PCT Filed: Jan. 30, 2006
(86) PCT No.: PCT/EP06/50515

§ 371 Date: May 13, 2008

(30) Foreign Application Priority Data
Mar. 8, 2005 (FR) 0502319

(51) Int. Cl. H04B 1/10

(52) U.S. Cl. 375/346

(57) ABSTRACT

A method is provided for the reception of a data signal comprising multiple carriers, known as a multi-carrier signal, which undergoes channel coding at transmission, said method employing an estimation of the received signal. One such reception method comprises at least one iteration for improving the estimation of the received signal, as a function of the received signal and of an estimation preceding from said received signal. One such iteration comprises, for each of the carriers of the received signal, a step involving the equalisation of the carrier with the cancellation of an interference affecting the received signal as a function of at least one statistical parameter of the estimation preceding from said received signal.

### FIELD OF THE INVENTION

The field of the invention is that of digital communications. More specifically, in a system of digital communications, the invention pertains to a technique for the iterative reception of a signal which has undergone channel encoding at transmission. The term “channel encoding” is understood here and throughout the document to mean a technique for the protection of information to be transmitted by insertion of redundant information.

The invention can be applied to wire-based digital communications systems such as the ADSL or “Asymmetric Digital Subscriber Line” systems as well as to radio-frequency systems using one or more transmit and/or receive antennas.

The invention also relates more particularly to reception technique adapted to multi-carrier system such as the OFDM (“Orthogonal Frequency Division Multiplexing” or MC-CDMA (“Multi-Carrier Code Division Multiplex Access”).

### PRIOR ART SOLUTIONS

There are many techniques for the reception of multi-carrier signals that have undergone channel encoding at transmission, designed to introduce redundancy into the signal.

Among these techniques, some (and this is the case with the present invention) rely on an iterative reception of signals enabling the improvement, as and when the iterations are performed, of the quality of estimation of the signal transmitted as a function of the signal received.

The following may be highlighted among these iterative techniques:

exhaustive-type receivers which implement a maximum likelihood (ML) type algorithm and have the drawback of inducing high complexity of processing, especially for MIMO type multiple-antenna transmission for example. Indeed, the complexity of these algorithms increases exponentially according to the number of antennas and the number of states of the modulation.

the receivers implementing linear decoding algorithms which have the advantage, as compared with maximum likelihood receivers of being far more complex.

The invention falls within the narrower field of linear iterative receivers for multi-carriers signals that have undergone channel encoding at transmission.

In “Low Complexity Iterative Receiver for Non-Orthogonal Space-Time Block Code with Channel Coding”, Proceedings of VTC, Los Angeles, USA, September 2004), P-J. Bouvet, M. Hélard and V. Le Nir have proposed a technique of iterative and linear reception for non-orthogonal block space-time codes.

In this article, the authors consider a MIMO channel model comprising a set of frequency-flat Rayleigh fading orthogonal channels. Indeed, a frequency-flat fading channel is equivalent to a multiple-path channel (with frequency fading) for which an OFDM modulation of the signal is performed.

As illustrated in FIG. 1, the (binary) signal 10 to be emitted undergoes a channel encoding CC 11, and then a interleave operation II 12. It then goes through a mapping module M 13, designed to convert binary elements into complex symbols: a module of this kind thus associates a group of bits with a complex symbol belonging to a constellation (of a QPSK, 64QAM or other type). The sequence of symbols output by the mapping module M 13 is commonly called an M-ary signal. A space-time block encoding 14 is then performed on each group of K symbols which are then sent on Nₜ transmit antennas 15₁, 15₂ to 15_{Nt} in a MIMO (“Multiple Input Multiple Output”) type transmission context.

The iterative receiver proposed derives advantage from the channel decoding to improve the space-time block decoding by eliminating interference terms.

More specifically, the proposed receiver (see FIG. 2) comprises two stages, namely a space-time demapper 24 (i.e. a converter of symbols in the binary elements) and a channel decoder 26 which exchanges extrinsic information in an iterative loop until the receiver converges. These stages are separated by an interleaver 22₁, used to decorrelate the outputs before giving them to the next decoding stage.

Thus, a signal r is received on N_{R} receive antennas referenced 25₁ to 25_{N}_{_{R}}. Each receive antenna 25₁ to 25_{N}_{_{R}} receives a linear combination of the symbols sent out on each of the Nₜ transmit antennas. The first “demapping” stage 24 comprises a first MMSE (“Minimum Mean Square Error”) type space-time linear decoding block 20. The equalized signal \tilde{s}^{(p)} output from the space-time decoding block 20 then powers a demapping module M⁻¹ 23₁, before undergoing a de-interleave operation II⁻¹ 22₁ and then a CC⁻¹ channel decoding operation 21. At output of the second channel decoding stage 26, an estimated binary signal \hat{d} is obtained.

Since the method is iterative, this estimated binary signal \hat{d} is subjected to a new interleaving II 22₂ and a new mapping M 23₂, in order to obtain an estimated M-ary signal ŝ, that can be reinjected into the MMSE space-time decoding block 20 for a following iteration for improving the estimation of received signal.

At the first iteration, the receiver carries out a classic MMSE type equalization of the received signal. During the following iterations, however, the previously estimated symbols are used by the space-time decoder to cancel a residual inter-element interference (IEI).

According to this technique, the co-antenna interference coming from the space-time encoding is therefore cancelled iteratively by means of a static coefficient interference canceller.

### DRAWBACKS OF THE PRIOR ART

One drawback of this prior art technique is that it cannot be used to cancel every type of interference affecting the signal. While it enables the cancellation of co-antenna interference linked to a MIMO type transmission context, it is on the other hand not suited to multi-user type interference cancellation (in an MC-CDMA or “Multi Carrier Code Division Multiple Access” type context) or to the cancellation of interference due to a linear pre-encoding of the signal before transmission.

Another drawback of this prior-art technique is that its performance is not the optimum and does not permit an estimation of adequate quality of the transmitted signal. In particular, an iterative reception method of this kind does not converge with sufficient speed or sufficient reliability towards the optimum limits.

### GOALS OF THE INVENTION

It is a goal of the invention especially to overcome these drawbacks of the prior art.

More specifically, it a goal of the invention to provide a technique of iterative reception with interference cancellation, of a multi-carrier signal that has undergone channel encoding prior to transmission, of improved performance as compared with the prior art techniques.

It is also a goal of the invention to provide a technique of this kind that is adapted to signals that may or may not have undergone linear pre-encoding at transmission in any type of transmission context with one or more receive and/or transmit antennas (SISO (“Single Input Single Output”), MIMO, etc.), whether or not in a multi-user (MC-CDMA) context. It may be recalled that linear pre-encoding consists of a multidimensional rotation of the transmission constellation.

It is another goal of the invention to propose a technique of this kind that can be used to cancel any type of interference affecting the signal, whether this interference is due to the system of transmission of the signal or to the transmission channel. In particular, the invention is aimed at proposing a technique of this kind that can be used to cancel co-antenna interference, multi-user interference or again interference due to linear pre-encoding, if any, of the signal.

It is yet another goal of the invention to provide a technique of this kind that is less complex than the prior-art techniques based on maximum likelihood.

### ESSENTIAL CHARACTERISTICS OF THE INVENTION

These goals as well as others that shall appear here below are achieved by means of a method of reception of a multiple-carrier data signal, called a multi-carrier signal, having undergone channel encoding at transmission, said method employing an estimation of the received signal, delivering an estimated signal.

According to the invention, a reception method of this kind comprises at least one iteration of improvement of said estimated signal as a function of said received signal and of a preceding estimated signal, and said iteration comprises, for each of said carriers of said received signal, a step of equalization of said carrier by cancellation of an interference affecting said received carrier, as a function of at least one statistical parameter of said previous estimated signal.

Thus, the invention relies on a fully novel and inventive approach to the iterative techniques of reception of multi-carrier signals with interference cancellation. Indeed, the method of the invention can be used for the iterative decoding of an encoded multi-carrier signal (and possibly linearly pre-encoded and/or space-time encoded) by the use of an interference-cancellation type equalizer whose coefficients are corrected in the course of the iterations. This gives the signal estimation process fast and reliable convergence towards the optimum convergence boundaries. The dynamic correction of the coefficients of the interference canceller is done as a function of statistical parameters of the signal estimated during the previous iteration, and does not take account solely of the transmission channel or of the noise (which would result in static coefficients).

The performance of such a reception method is therefore improved by the use of a multi-carrier signal, for example of the OFDM (orthogonal frequency division multiplexing) type. Indeed, while the intrinsic structure of a multi-carrier signal of this kind is already designed to reduce interference, the invention proposes the use of an interference cancellation structure at reception of such a signal, which could seem to be unnecessary and redundant to those skilled in the art.

Finally, the processing proposed by the invention is a block processing of the received signal, performed carrier by carrier.

Advantageously, said iteration comprises the following steps for each of said carriers:

filtering of said received carrier, delivering a filtered carrier;

determining an interference that affects said received carrier, generated at transmission of said multi-carrier signal and/or due to the transmission channel of said multi-carrier signal, said determining step delivering an estimated interference;

subtraction of said estimated interference from said filtered carrier so as to obtain an improved carrier;

equalization of said improved carrier, delivering an equalized carrier;

estimation, from at least said equalized carrier, of the sent carrier, delivering an estimated carrier,

and said estimated signal takes account of each of said estimated carriers.

Thus, the method of the invention has the characteristic feature of carrying out a processing of the signal, carrier by carrier, and enables the processing of any type of interference, whether it is of a co-antenna, multi-user type or again whether it is due to a linear pre-encoding of the signal. The estimation of the carrier sent may take account of one or more equalized carriers of the signal, as a function of the channel encoding.

Preferably, said filtering step applies a multiplication of a vector representing said carrier received by a filtering matrix taking account of at least one representative matrix representing said transmission channel, of a signal-to-noise ratio and of said statistical parameter.

According to one advantageous characteristic, said step for determining interference employs a multiplication of a vector representing said previous estimated carrier by an interference matrix taking account of at least said matrix representing said transmission channel and said statistical parameter.

Preferably, said statistical parameter is the variance of said preceding estimation of said received signal. The interference cancellation of the invention takes account, via the variance, of the energy of the estimate of the transmitted signal.

Advantageously, said preceding estimation is delivered by the preceding iteration for all the iterations except the first one, and is delivered by a step of preliminary estimation for the first iteration.

In an advantageous variant of the invention, said multi-carrier signal undergoes a linear pre-encoding at transmission by multiplication by a pre-encoding matrix, and said filtering and interference matrices also take account of said pre-encoding matrix.

In another advantageous variant of the invention, said multi-carrier signal undergoes space-time encoding at transmission and is transmitted by and/or received on at least two antennas. The context therefore is that of MIMO type transmission.

These two alternative embodiments can of course be combined to obtain MIMO type transmission of a linearly pre-encoded multi-carrier signal.

The invention also relates to a receiver of a multiple-carrier data signal, called a multi-carrier signal, having undergone channel encoding at transmission, said receiver comprising means of estimation of the received signal, delivering an estimated signal. According to the invention, a receiver of this kind comprises means of improvement of said estimated signal, as a function of said received signal and of a preceding estimated signal, implementing at least once, in the form of a iteration, and for each of said carriers of said received signal, means of equalization of said carrier by cancellation of an interference affecting said received carrier, as a function of at least one statistical parameter of said previous estimated signal.

The invention also relates to a computer program product comprising program code instructions for the execution of the steps of the method of reception of a multiple-carrier data signal described previously when said program is executed in or by a microprocessor.

### LIST OF FIGURES

Other features and advantages of the invention shall appear more clearly from the following description of a preferred embodiment given as a simple and non-restrictive illustration and from the appended drawings, of which:

FIG. 1 is a block diagram of a prior art transmission scheme;

FIG. 2, already described here above, illustrates the receiver of the signal sent according to the scheme of FIG. 1;

FIG. 3 is a block diagram of the processing performed on a carrier during an iteration for the improvement of the estimated signal of the invention;

FIG. 4 illustrates the iterative structure of a receiver of the invention;

FIG. 5 presents the processing implemented on each carrier during the first estimation of the received signal;

FIG. 6 shows the transmission scheme for a multi-carrier signal in a context of SISO transmission with linear pre-encoding;

FIG. 7 is a schematic view of the transmission channel in the SISO type transmission-reception system of FIG. 6;

FIG. 8 shows the transmission scheme for a multi-carrier signal in a context of MIMO transmission with linear pre-encoding;

FIG. 9 is a schematic illustration of the transmission channel in a MIMO type transmission-reception system with four receive antennas and four transmit antennas;

FIG. 10 is a schematic illustration of the transmission channel in a MISO type transmission-reception system with one receive antenna and four transmit antennas;

FIG. 11 shows the transmission scheme for a multi-carrier signal in a context of MIMO transmission with linear pre-encoding;

FIG. 12 is a block diagram of the receiver of the invention;

FIGS. 13a and 13b illustrate the principle of OFDM modulation before transmission and OFDM demodulation at reception, by frequency distribution followed by time distribution of the symbol in the context of SISO transmission with linear pre-encoding of FIG. 6;

FIGS. 14a and 14b pertain to an embodiment that is an alternative to those of FIGS. 13a and 13b, when the symbols are subjected to arbitrary time distribution and frequency distribution;

FIGS. 15a and 15b present this same principle of OFDM modulation/demodulation in the context of MIMO transmission of FIG. 8;

FIGS. 16a and 16b finally illustrate this principle of OFDM modulation/demodulation in the context of MIMO transmission with linear pre-encoding as described in FIG. 11.

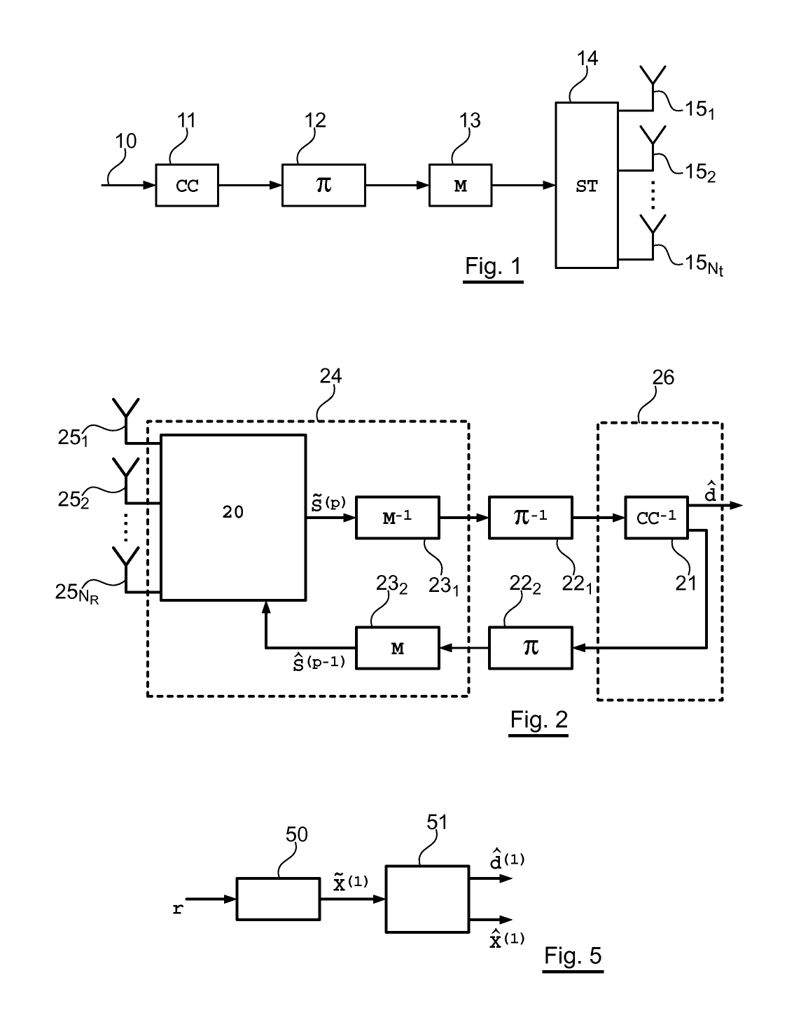

### DESCRIPTION OF EMBODIMENTS OF THE INVENTION

The general principle of the invention relies on the iterative reception of multi-carrier signals that have undergone channel encoding at transmission. This iterative reception employs an interference cancellation whose coefficients are dynamically modified in the course of the iterations as a function of statistical parameters (such as energy or variance) of the previously estimated signal.

It can be implemented in a single-antenna or multi-antenna transmission context, in a MC-CDMA or non-MC-CDMA type multi-user system, with or without linear pre-encoding at transmission.

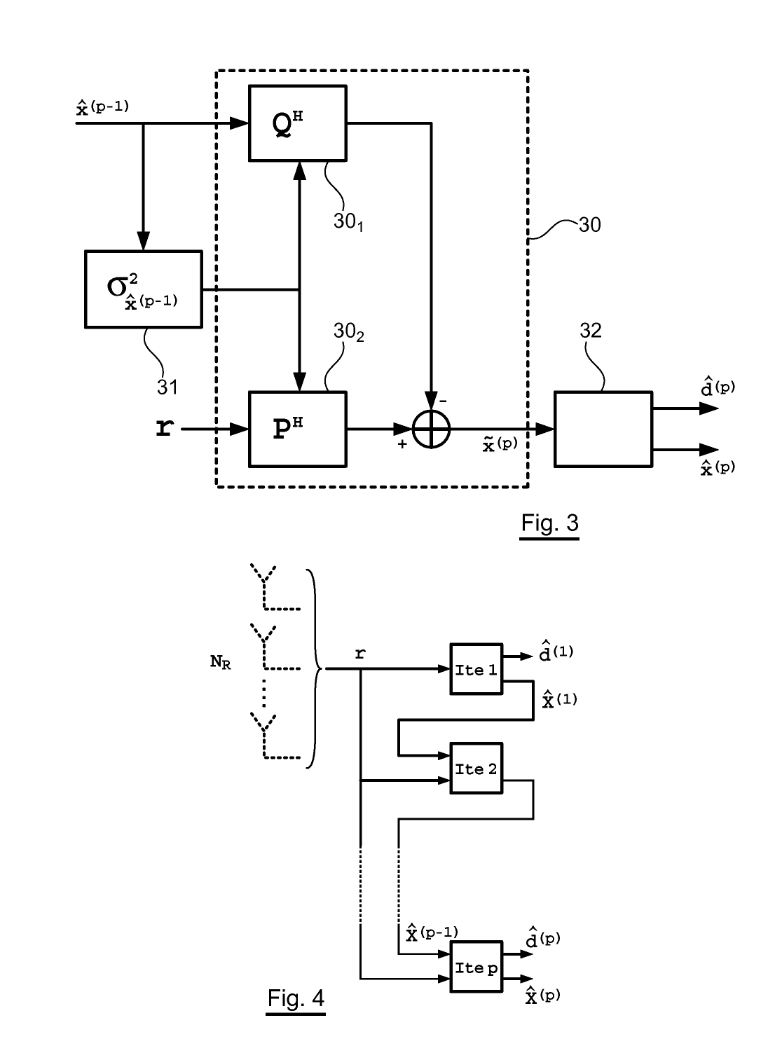

FIG. 3 is a block diagram of the iteration for improvement of the estimation of the received signal implemented according the invention. At input, there is a vector \hat{x}^{(p-1)} (also called ŝ(p-1) in other figures) representing one or more carriers of the multi-carrier signal estimated in the (p-1) ranking estimation. We consider for example the vector \hat{x}^{(p-1)}(k) representing the k ranking carrier of the multi-carrier signal. In another embodiment, \hat{x}^{(p-1)} may represent a group of carriers.

The operating principle of the diagram of FIG. 3 is as follows: the procedure is performed carrier by carrier (or carrier group by carrier group) and, at each iteration, an interference term is removed from the preliminarily filtered received signal, this interference term being estimated from estimations of the transmitted signal given by the preceding iterations. This cancellation of interferences takes account of the variance, or energy, of the estimate of the transmitted signal. The closer this energy is to zero, the greater the extent to which the filtered received signal and the estimated interferences is corrected. Conversely, the closer this energy is to the energy of the transmitted signal, the smaller the extent to which this correction is implemented.

More specifically, an equalization is carried out for each of the carriers of the received signal, according to the following formula:

\hat{x}^{(p)}(k)=P^{H}r(k)−Q^{H}\hat{x}^{(p-1)}(k), where:

\hat{x}^{(p)}(k) designates the vector representing the signal equalized at the iteration p for the carrier k or the group of carriers indexed k.

\hat{x}^{(p-1)}(k) designates the vector representing the signal estimated at the iteration (p-1) for the carrier k or the group of carriers indexed k,

r(k) designates the signal received after OFDM demodulation on the carrier k or the group of carriers indexed k

and where P^{H} and Q^{H} are two matrix filters having the following form:

$$\{ \begin{matrix}{P}^{H} = {[ {C}^{H} C ( \frac{{σ}_{x}^{2} - {σ}_{{\hat{x}}^{( p - 1 )}}^{2}}{{σ}_{x}^{2}} ) + \frac{{σ}_{n}^{2}}{{σ}_{x}^{2}} I ]}^{- 1} \cdot {C}^{H} \\ {Q}^{H} = d diag ( {P}^{H} C )\end{matrix}$$

with C as a matrix representing the transmission channel (and comprising, if necessary, linear pre-encoding if such pre-encoding is applied at transmission), I the identity matrix, σₓ² the variance of the signal x sent, σ_{\hat{x}}_{^{(p-1)}}² the variance of the signal estimated at iteration (p-1) and

$$\frac{{σ}_{n}^{2}}{{σ}_{x}^{2}}$$

the inverse of the mean signal-to-noise ratio. It will be noted that the operator (.)^{H} designates the conjugate transposed operator and that the operator ddiag(.) associates a matrix ddiag(A) with a matrix A, all the terms of this matrix ddiag(A) being identical with those of the matrix A except for the diagonal terms which are equal to zero.

For the sake of simplification, the description of FIG. 3 here below does not cover the index k of the carrier considered or of the group of carriers considered. It will be noted however that the processing corresponding to the diagram of this figure is a processing applied to the received signal carrier by carrier.

The variance computation block 31 computes the variance σ_{\hat{x}}_{^{(p-1)}}² of the M-ary signal estimated at the (p-1) ranking iteration, in taking the average of the energy of this signal on a sufficient number of samples:

$${σ}_{{\hat{x}}^{( p - 1 )}}^{2} = {\sum }_{n = 0}^{N} {\vert {\hat{x}}_{n}^{( p - 1 )} \vert}^{2} ,$$

where N is a sufficiently great integer (for example N=10000). The N samples correspond to N temporal symbols on one or more carriers as a function of the size of the system considered. A computation of time-related variance is therefore performed on the OFDM spectrum.

The equalization block 30, working by interference cancellation, receives at input the estimated M-ary signal \hat{x}^{(p-1)} coming from the preceding iteration and the received signal r, for the carrier k, or the group of carriers indexed k. It performs the following operations:

matched filtering 30₂ of the received signal r by application of the filtering matrix P^{H} delivering a filtered signal. This filtering takes account of the variance of the preceding estimated M-ary signal, the channel matrix and of the signal-to-noise ratio

$$\frac{{σ}_{n}^{2}}{{σ}_{x}^{2}}$$

as indicated in the formula proposed here above for P^{H}. σₓ² is often fixed as being equal to 1 in transmission, and σₙ² is the estimated noise in reception, for example by means of pilot sequences. Thus, at output of the filtering block 30₂, a filtered signal is obtained for the carrier k or the group of carriers indexed k;

creation 30₁ of the interferences from a preceding estimated M-ary signal \hat{x}^{(p-1)} by left multiplication of this preceding estimated M-ary signal by an interference matrix Q^{H}, which takes account of the channel matrix and of the variance of the preceding estimated M-ary signal σ_{\hat{x}}_{^{(p-1)}}². This form of filtering of the estimated signal makes it possible to weight the correction made by the interference canceller. An estimated interference signal is thus obtained at output of the block 30₁;

subtraction of the estimated interference signal obtained at output of the block referenced 30₁ from the filtered signal obtained at output of the filtering block 30₂ to obtain an equalized M-ary signal \hat{x}^{(p)} for the carrier k or the group of carriers indexed k.

The equalized M-ary signal \hat{x}^{(p)} is then fed into the estimation block 32 which does the estimation of:

the binary signal sent, called an estimated binary signal \hat{d}^{(p)};

the M-ary signal sent, called an estimated M-ary signal \hat{x}^{(p)} for the carrier k or the group of carriers indexed k.

or of only one of these signals.

The estimation block 32 can carry out especially certain of the following operations:

<<mapping>>(i.e. the conversion of binary elements into complex symbols)

de-interleaving;

channel decoding;

re-interleaving;

soft <<mapping>>.

Indeed, the modulation used may be, for example, a trellis-encoded modulation (or TCM).

FIG. 4 provides a more precise illustration of a receiver according to the invention. Such a receiver is of an iterative type and is constituted by p elementary modules (p>1) referenced Ite1, Ite2 to Itep. In the example of FIG. 4, the signal r is received at N_{R} receive antennas. The invention can of course be applied also to the case of single-antenna transmissions.

The signal r received at the N_{R} receive antennas of the MIMO system considered is delivered to the first elementary module Ite1 of the receiver, illustrated in FIG. 5, where it undergoes the first iteration (p=1) of the reception method of the invention. This first iteration consists of an initialization phase as no M-ary signal is as yet available, and therefore comprises the following steps:

first of all, a classic equalization 50 of the received signal r is performed by multiplication by an equalization matrix taking account of the matrix representing the transmission channel, the linear pre-encoding if it has been implemented at transmission, and the signal-to-noise ratio

$$\frac{{σ}_{n}^{2}}{{σ}_{x}^{2}} .$$

This equalization 50 delivers an equalized M-ary signal \hat{x}⁽¹⁾. Such an equalization is, for example, of an MMSE type;

the equalized M-ary signal \hat{x}⁽¹⁾ is then fed into an estimation block 51 for estimation of the binary signal and of the M-ary signal which, from the equalized M-ary signal, delivers an estimated binary signal \hat{d}⁽¹⁾ (which possibly is not exploited and, therefore, is not necessarily available at output) and an estimated M-ary signal \hat{x}⁽¹⁾.

The estimated M-ary signal \hat{x}⁽¹⁾ is then injected into the next elementary module Ite2. FIG. 3, already commented upon here above, illustrates the structure of a elementary module Itep, where p>1, which includes a first equalization block 30 working by interference cancellation and a second symbol estimation block 32.

Certain of the elementary modules Ite1 to Itep performing the estimation of the received signal deliver firstly a binary estimation a of this received signal and, secondly, a weighted estimation \hat{x} of this received signal. It is this soft estimation that is used for the following iteration if this iteration exists.

The process of improvement of the estimated signal can be stopped at any time, at the end of any one of the iterations Ite1 to Itep. Generally, the iterations are stopped when \hat{x}^{(p)}≈\hat{x}^{(p+1)}, or more specifically when the difference between the estimated signals coming from two successive iterations is below a predetermined quality threshold. This threshold may be fixed as a function of the needs of the application in view.

FIG. 12 is a simplified block diagram of the iterative receiver of the invention, which comprises a memory M 121, a processing unit P 120, equipped for example with a microprocessor, and driven by the computer program Pg 122. At initialization, the code instructions of the computer program 122 are loaded for example into a RAM 121 and then executed by the processor of the processing unit 120. The processing unit 120 receives the received signal r at input. The microprocessor μP of the processing unit 120 carries out the iterative equalization and estimation of the signal, described in detail with reference to FIGS. 3, 4 and 5, according to the instructions of the program Pg 122. The processing unit 120 outputs an estimated binary signal \hat{d} and an estimated M-ary signal \hat{x}.

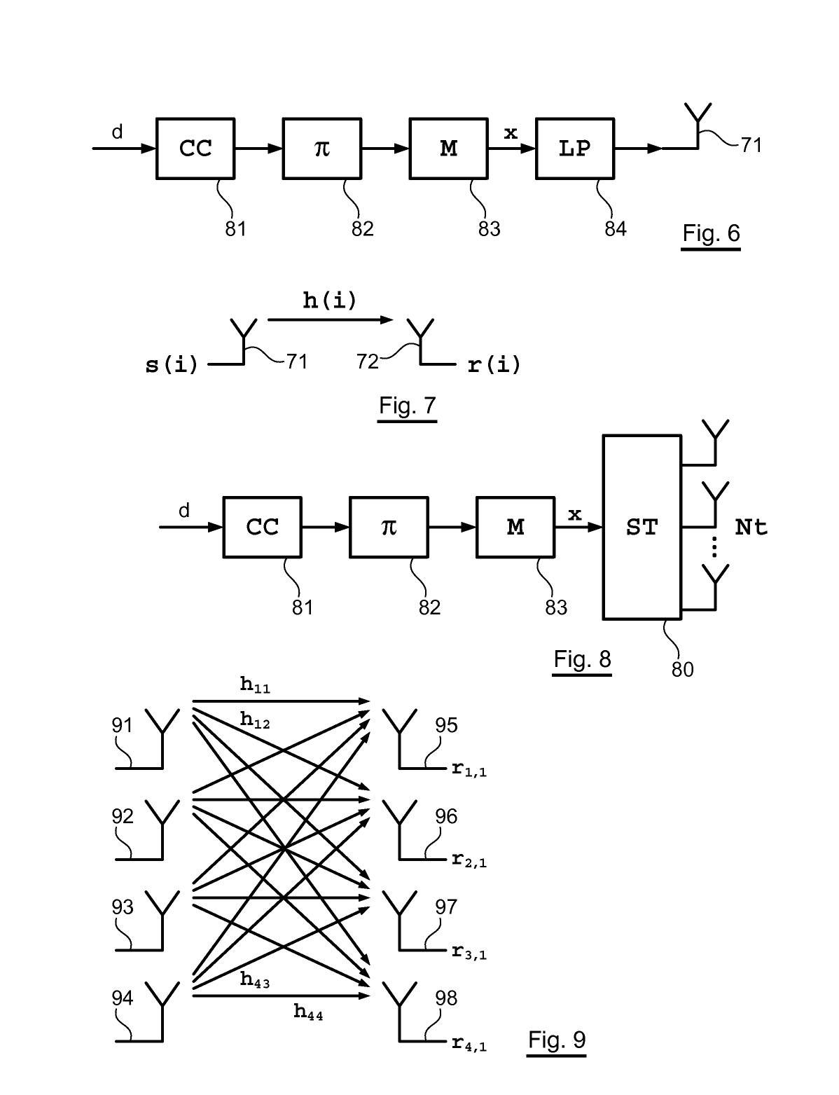

Referring to FIGS. 6 to 8, the description is now focused on three exemplary embodiments of the invention in SISO and MIMO type transmission systems with or without linear pre-encoding.

SISO Transmission with Linear Pre-Encoding

In a first embodiment, the multi-carrier signal undergoes a linear pre-encoding before transmission so as to introduce diversity of space. To this end, the vectors representing the signal to be sent are multiplied by a pre-encoding matrix sized L:

$${Θ}_{L} = \frac{2}{\sqrt{L}} ⌊ \begin{matrix}{Θ}_{L / 2} & {Θ}_{L / 2} \\ {Θ}_{L / 2} & - {Θ}_{L / 2}\end{matrix} ⌋$$

$$with \text{:}$$

$${Θ}_{2} = \frac{2}{\sqrt{L}} ⌊ \begin{matrix}{e}^{j {ϑ}_{1}} cos η & {e}^{j {ϑ}_{2}} sin η \\ - {e}^{- j {ϑ}_{2}} sin η & {e}^{- j {ϑ}_{1}} cos η\end{matrix} ⌋$$

FIG. 6 illustrates the signal transmission scheme in a SISO system of this kind with linear pre-encoding. The binary signal to be sent undergoes a channel encoding CC 81, a II interleave operation 82 and a “mapping” M 83, which converts the binary elements into symbols of the constellation used (QPSK, 16QAM, etc.). The M-ary signal x to be sent then undergoes a linear pre-encoding LP 84, before it is transmitted by the single transmit antenna 71.

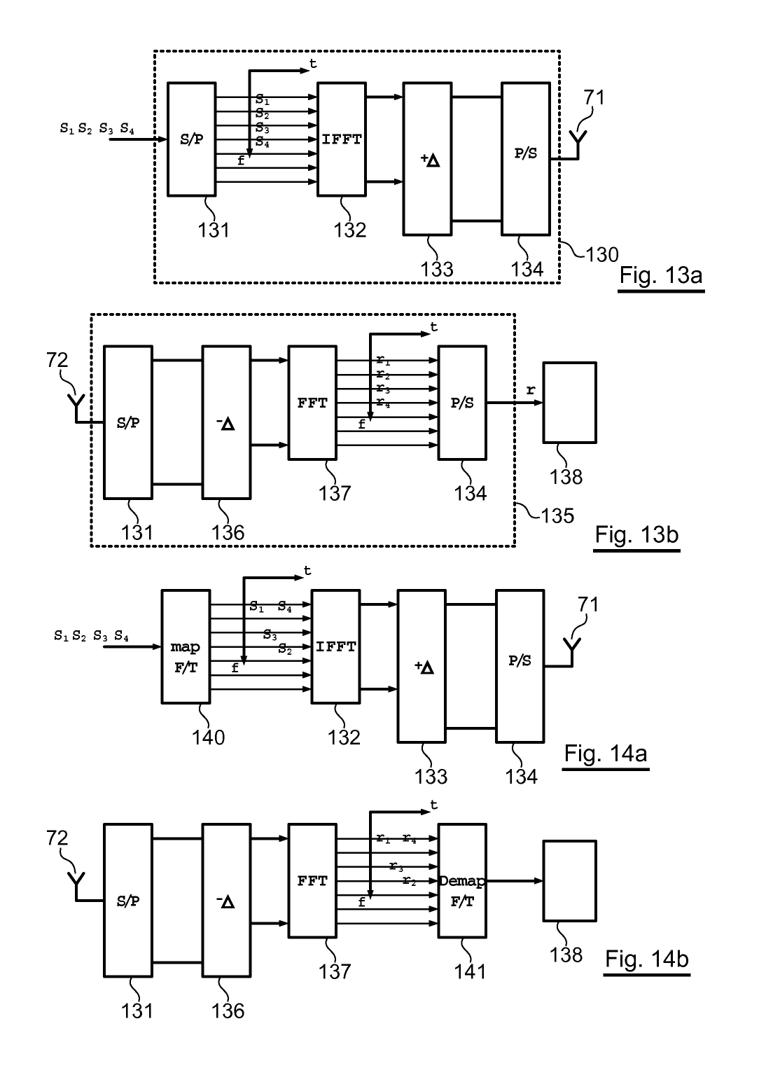

More specifically, the M-ary signal to be sent undergoes an OFDM modulation before it is sent. If we consider, for example, a linear pre-encoding LP 84 sized Lp=4, the M-ary signal x to be sent can be represented in the form of the following pre-encoded symbol vector: [s₁ s₂ s₃ s₄]^{T}. The four pre-encoded symbols can be distributed in different ways in the time-frequency plane as illustrated by FIGS. 13 and 14.

In a first classic technique illustrated by FIGS. 13a and 13b, the symbols s₁ to s₄ are frequency distributed f, then time distributed t. To this end, a simple series/parallel conversion S/P 131 is used.

The OFDM modulation 130 of the pre-encoded signal therefore comprises the successive blocks presented in FIG. 13a, namely:

a series/parallel conversion S/P 131 enabling time-frequency plane distribution of the symbols s₁ to s₄;

an inverse fast Fourier transform IFFT 132

a guard interval insertion block +Δ 133;

a parallel/series conversion block P/S 134.

Symmetrically, at reception, an OFDM demodulation 135 is performed on the signal received at the receive antenna 72 (FIG. 13b), by performing the following operations:

series/parallel conversion S/P 131 of the received signal;

elimination −Δ 136 of the guard interval;

forward fast Fourier transform FFT 137;

parallel/series conversion P/S 134 enabling retrieval of the received symbols r₁ to r₄ distributed in the time-frequency plane.

At the end of the OFDM demodulation 135, the received signal

$$r = [ \begin{matrix}{r}_{1} \\ {r}_{2} \\ {r}_{3} \\ {r}_{4}\end{matrix} ]$$

is fed into the iterative receiver 138 of the invention as illustrated for example in FIG. 4.

FIGS. 14a and 14b illustrate a second OFDM technique for modulation of the signal to be sent and distribution of the symbols s₁ to s₄ in the time-frequency plane. In this second technique, the pre-encoded symbols are mapped arbitrarily in time and frequency as illustrated by the distribution of the symbols s₁ to s₄ in the time-frequency plane t-f in FIG. 14a.

The transmission scheme (FIG. 14a) differs from that of FIG. 13a in that the S/P conversion block 131 is replaced by a frequency/time mapping block “map F/T” 140. The other elements are identical to those of FIG. 13a.

Similarly, the reception scheme of FIG. 14b differs solely from that of FIG. 13b in that the parallel/series P/S conversion block 134 is replaced by a frequency-time demapping block <<Demap F/T>>used to reconstruct the received vector r from the different symbols r₁ to r₄ distributed in the time-frequency plane t-f.

FIG. 7 provides a schematic view of the transmission channel followed by the multi-carrier signal s(i), from the single transmit antenna 71 to the single receive antenna 72. Let h(i) be the coefficient of the channel between the transmit antenna and the receive antenna at the symbol time i.

The following is the equivalent channel matrix:

$$H = [ \begin{matrix}h ( i ) & 0 & 0 & 0 \\ 0 & h ( i + 1 ) & 0 & 0 \\ ⋮ & 0 & ⋱ & ⋮ \\ 0 & 0 & … & h ( i + L - 1 )\end{matrix} ]$$

In this particular embodiment, the iterative receiver of the invention uses the matrix C defined such that:

C=H·Θ_{L}

as well as the vector r defined such that:

$$r = [ \begin{matrix}{r}_{1} \\ ⋮ \\ {r}_{L}\end{matrix} ]$$

It is assumed that, at each iteration, an estimate of the transmitted signal is available (given by the previous iteration). It is also assumed that the variance of the noise as well the matrix C is known to the receiver (the matrix H representing the transmission channel is for example determined according to a classic channel estimation technique implemented when the receiver is initialized, by means of reference symbols or pilot carriers).

Referring to FIG. 3, we first compute (31) the variance of the estimated signal σ_{\hat{x}}_{^{(p-1)}}² in taking the average of this signal on a sufficient number of samples:

$${σ}_{{\hat{x}}^{( p - 1 )}}^{2} = {\sum }_{n = 0}^{N} {\vert {\hat{x}}_{n}^{( p - 1 )} \vert}^{2}$$

where N is a sufficiently great integer (for example N=10000).

A filtering (30₂) is then performed, carrier by carrier (or carrier group by carrier group), on the received signal r using a matrix P^{H} taking account of at least the channel matrix, the pre-encoding matrix, the variance of the estimated signal σ_{\hat{x}}_{^{(p-1)}}² and the signal-to-noise ratio

$$\frac{{σ}_{n}^{2}}{{σ}_{x}^{2}}$$

to obtain a filtered signal.

Furthermore, the signal estimated at the preceding iteration \hat{x}^{(P-1)} is multiplied (30₁), carrier by carrier (or carrier group by carrier group) by a matrix Q^{H} representing the interferences taking account at least of the channel matrix of the pre-encoding matrix and of the variance of the estimated signal. Thus an estimated interference signal is obtained.

Then, the estimated interference signal is subtracted from the filtered signal, giving an equalized signal \hat{x}^{(p)}.

In the estimation module 32, the following are then performed:

the estimation, from the equalized signal, of the binary signal sent, called an estimated binary signal \hat{d}^{(p)};

the estimation, from the equalized signal, of the M-ary signal called an estimated M-ary signal \hat{x}^{(p).}

The term “estimation” covers mapping operations as well as de-interleaving, channel decoding, re-interleaving and soft mapping.

For each carrier k, or each group of carriers indexed k, of the multi-carrier signal, the equalized signal is therefore expressed in the form:

\hat{x}^{(p)}=P^{H}r−Q^{H}\hat{x}^{(p-1)}

where the two matrix filters P and Q have the form:

$$\{ \begin{matrix}{P}^{H} = {[ {C}^{H} C ( \frac{{σ}_{x}^{2} - {σ}_{{\hat{x}}^{( p - 1 )}}^{2}}{{σ}_{x}^{2}} ) + \frac{{σ}_{n}^{2}}{{σ}_{x}^{2}} I ]}^{- 1} \cdot {C}^{H} \\ {Q}^{H} = ddiag ( {P}^{H} C )\end{matrix}$$

For the first iteration implemented by the receiver, for which there is not yet any previous estimated signal available, a classic equalization is carried out, followed by a symbol estimation:

$${\tilde{x}}^{( p )} = {[ {C}^{H} C + \frac{{σ}_{n}^{2}}{{σ}_{x}^{2}} I ]}^{- 1} \cdot {C}^{H} r$$

More specifically, the following operations are performed:

multiplication of the vector r representing the carrier k of the signal received by a matrix taking account at least of the channel, the linear pre-encoding and the signal-to-noise ratio

$$\frac{{σ}_{n}^{2}}{{σ}_{x}^{2}} .$$

Thus an equalized signal \hat{x}⁽¹⁾ is obtained,

estimation, from the equalized signal, of the binary signal sent, called an estimated binary signal \hat{d}⁽¹⁾;

estimation, from the equalized signal, of the M-ary signal sent called an estimated M-ary signal \hat{x}⁽¹⁾.

It is noted that the equalized signal \hat{x}⁽¹⁾ can be obtained with the interference cancellation structure of FIG. 3, in fixing σ_{\hat{x}}_{^{(p-1)}}²=0 and \hat{x}^{(p-1)=}0.

MIMO Transmission without Linear Pre-Encoding

In this second particular exemplary embodiment, a transmission without linear pre-encoding is assumed. The description is situated in the context of MIMO type multi-antenna transmission in which the multi-carrier signal undergoes space-time encoding or ST mapping before transmission.

FIG. 8 illustrates the transmission structure for the signal in this particular example of an embodiment of the invention. The binary signal d undergoes channel encoding CC 81, followed by a II interleave operation 82 then a mapping M 83 (i.e. a conversion of the binary elements into symbols of a constellation) which generates a M-ary signal x. The space-time encoding module ST 80 (or “mapper”) takes a block of K symbols at input and delivers T symbols on the Nₜ transmit antennas. The processing implemented at reception on each of the carriers of the signal is identical to the one described here above with reference to FIG. 3.

The matrix Q^{H} representing interferences, by which the estimated signal \hat{x}^{(p-1)} is multiplied takes account at least of the channel matrix and of the variance of the estimated signal. At the end of this multiplication, an estimated interference signal is obtained.

Furthermore, during the first iteration of the receiver, before an estimated signal is available for the first time, each vector representing a carrier k of the received signal r is multiplied by a matrix taking account at least of the channel and of the signal-to-noise ratio

$$\frac{{σ}_{n}^{2}}{{σ}_{x}^{2}} .$$

This multiplication delivers an equalized signal \hat{x}^{(1).}

Finally, the matrix C and the vector r used are defined according to the space-time encoding used in the following paragraphs 7.2.1 and 7.2.2.

Spatial Multiplexing

We assume a MIMO channel with four transmit antennas 91 to 94 (or Tx 1 to Tx 4) and four receive antennas 95 to 98, as illustrated in FIG. 9.

The encoding scheme adopted is of a spatial multiplexing type. For a block of K=4 data symbols s₁, s₂, s₃ and s₄, the space-time mapper ST 80 multiplexes the data on a time interval IT1 according to the following scheme:

TABLE 1
space multiplexing (K = 4, T = 1, Nt = 4)

| | Antenna Tx 1 | Antenna Tx 2 | Antenna Tx 3 | Antenna Tx 4 |
|---|---|---|---|---|
| IT1 | s₁ | s₂ | s₃ | s₄ |

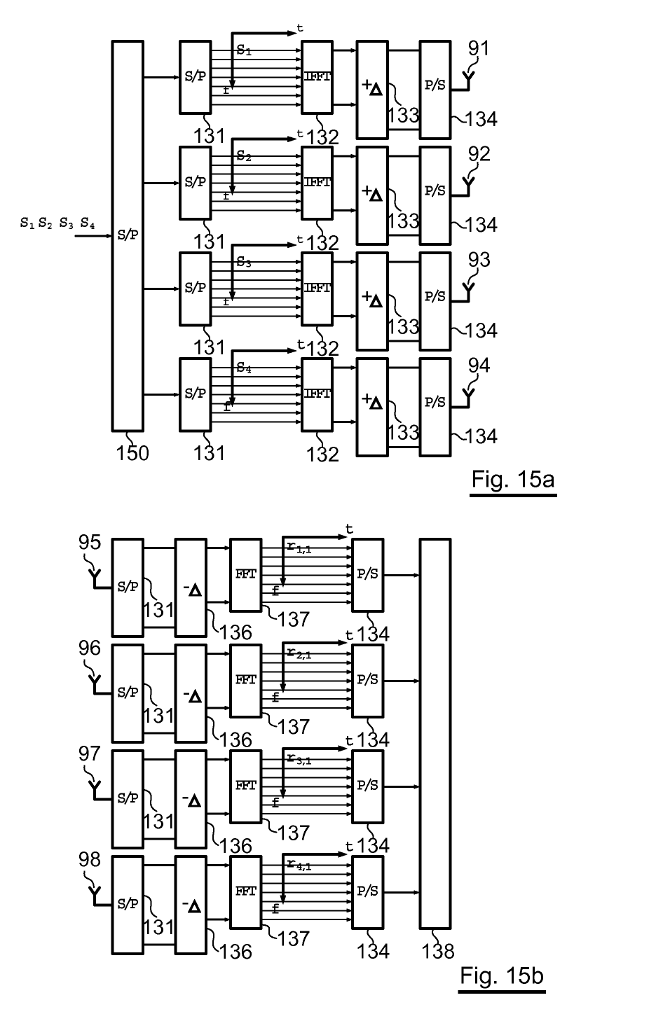

FIG. 15a provides a more precise illustration of this space multiplexing technique applied to the M-ary signal constituted by the symbols s₁, s₂, s₃ and s₄. The M-ary signal undergoes a series/parallel conversion S/P 150 which enables the distribution of each of the symbols s₁ to s₄ to a distinct processing channel. Each of these processing channels is then identical to the scheme of FIG. 13a, i.e. each of the symbols s₁ to s₄ undergoes a series/parallel conversion S/P 131, an IFFT 132, the insertion of a guard interval 133, and then a parallel/series conversion P/S 134 before it is sent. Let hᵢⱼ be the channel coefficient between the antenna i and the antenna j and rⱼₖ the symbol received at the antenna j during the time interval k.

The equivalent channel matrix is the following:

$$H = [ \begin{matrix}{h}_{11} & {h}_{21} & {h}_{31} & {h}_{41} \\ {h}_{12} & {h}_{22} & {h}_{32} & {h}_{42} \\ {h}_{13} & {h}_{23} & {h}_{33} & {h}_{43} \\ {h}_{14} & {h}_{24} & {h}_{34} & {h}_{44}\end{matrix} ]$$

The iterative receiver uses the matrix C defined such that:

C=H

and the received vector is:

$$r = [ \begin{matrix}{r}_{1 , 1} \\ {r}_{2 , 1} \\ {r}_{3 , 1} \\ {r}_{4 , 1}\end{matrix} ]$$

FIG. 15b illustrates the reception scheme corresponding to the transmission scheme of FIG. 15a. A processing channel identical to the reception scheme of FIG. 13b is associated with each of the receive antennas 95 to 98, and processes one of the components r_{1,1} to r_{4, 1} of the received vector r. The iterative receiver 138 uses the above received vector r and processes the carriers of each antenna one by one. As mentioned here above in the case of the SISO (FIGS. 14a and 14b), it can be imagined that the symbols, at transmission, are subjected to arbitrary time and frequency distribution. In this case, the dual operation must be performed for each antenna, upstream to the iterative receiver 138. The P/S blocks 134 in FIG. 15b would then be replaced by “Demap F/T” blocks 141.

Space-Time Encoding

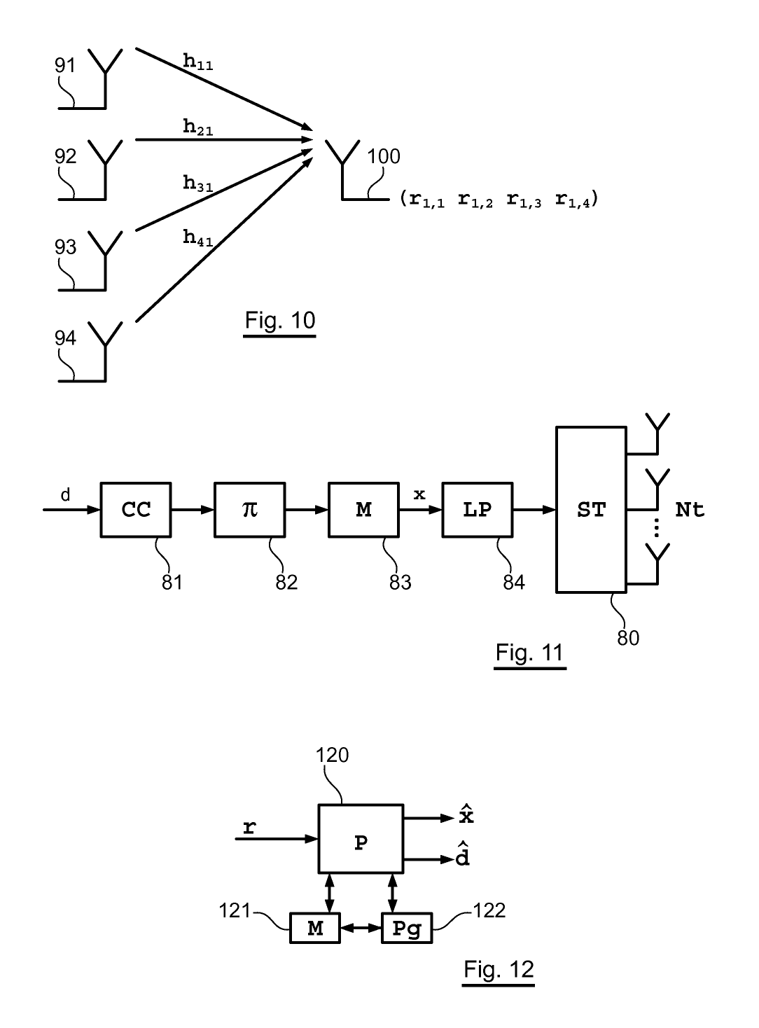

We assume a MISO channel with four transmit antennas 91 to 94 (or Tx 1 to Tx 4) and one receive antenna 100, as illustrated in FIG. 10. The encoding scheme adopted is of the Jafarkhani type (as described for example in “A Quasi-Orthogonal Space-Time Block Code”, IEEE Transactions on Communications, vol. 49, pp. 1-4, Jan 2001). For a four-symbol data block s₁, s₂, s₃ and s₄, the space-time mapper ST 80 multiplexes the data on four time intervals IT1 IT2, IT3 and IT4 according to the following scheme:

TABLE 2
Jafarkhani space-time encoding (K = 4, T = 4, Nt = 4)

| | Antenna Tx 1 | Antenna Tx 2 | Antenna Tx 3 | Antenna Tx 4 |
|---|---|---|---|---|
| IT1 | s₁ | s₂ | s₃ | s₄ |
| IT2 | −s₂* | s₁* | −s₄* | s₃* |
| IT3 | −s₃* | −s₄* | s₁* | s₂* |
| IT4 | s₄ | −s₃ | −s₂ | s₁ |

Let hᵢⱼ be the channel coefficient between the antenna i and the antenna j. It is assumed that this coefficient remains constant on all four time intervals IT1 to IT4. rⱼₖ is the symbol received at the antenna j during the time interval k.

At reception, the iterative system of the invention uses the vector r defined such that:

$$r = [ \begin{matrix}{r}_{1 , 1} \\ {r}_{1 , 2}^{*} \\ {r}_{1 , 3}^{*} \\ {r}_{1 , 4}\end{matrix} ]$$

As well as the following matrix C:

$$C = [ \begin{matrix}{h}_{11} & {h}_{21} & {h}_{31} & {h}_{41} \\ {h}_{12}^{*} & - {h}_{11}^{*} & {h}_{41}^{*} & - {h}_{31}^{*} \\ {h}_{31}^{*} & {h}_{41}^{*} & - {h}_{11}^{*} & - {h}_{21}^{*} \\ {h}_{41} & - {h}_{31} & - {h}_{21} & {h}_{11}\end{matrix} ]$$

MIMO Transmission with Linear Pre-Encoding

Finally, we present a last example of an embodiment of the invention, in a context of MIMO type transmission, in which the multi-carrier signal undergoes linear pre-encoding at transmission.

FIG. 11 illustrates the structure of transmission of the multi-carrier signal in this context. This FIG. 11 is identical to FIG. 8 commented upon here above with the exception of the linear pre-encoding LP block 84, and shall therefore not be described in greater detail here.

The processing performed at reception on each of the carriers of the signal is identical to the processing described here above with reference to FIG. 3. Only the matrix C and the vector r are different and defined as follows.

A MIMO transmission system as described in paragraph 7.2 (with spatial multiplexing or space-time encoding of the multi-carrier signal at transmission) is considered. In the case of transmission with linear pre-encoding of the signal, the iterative receiver uses the following matrix C:

$$C = [ \begin{matrix}{C}_{1} & 0 & 0 \\ 0 & & 0 \\ 0 & 0 & {C}_{\frac{{N}_{r} {TL}_{p}}{K}}\end{matrix} ]$$

where each matrix Cₖ is the matrix C defined in the preceding section 7.2. The vector r is defined such that:

$$r = [ \begin{matrix}{r}_{1} \\ ⋮ \\ {r}_{\frac{{N}_{r} {TL}_{p}}{K}}\end{matrix} ]$$

where the values rₖ are as defined in the preceding section 7.2.

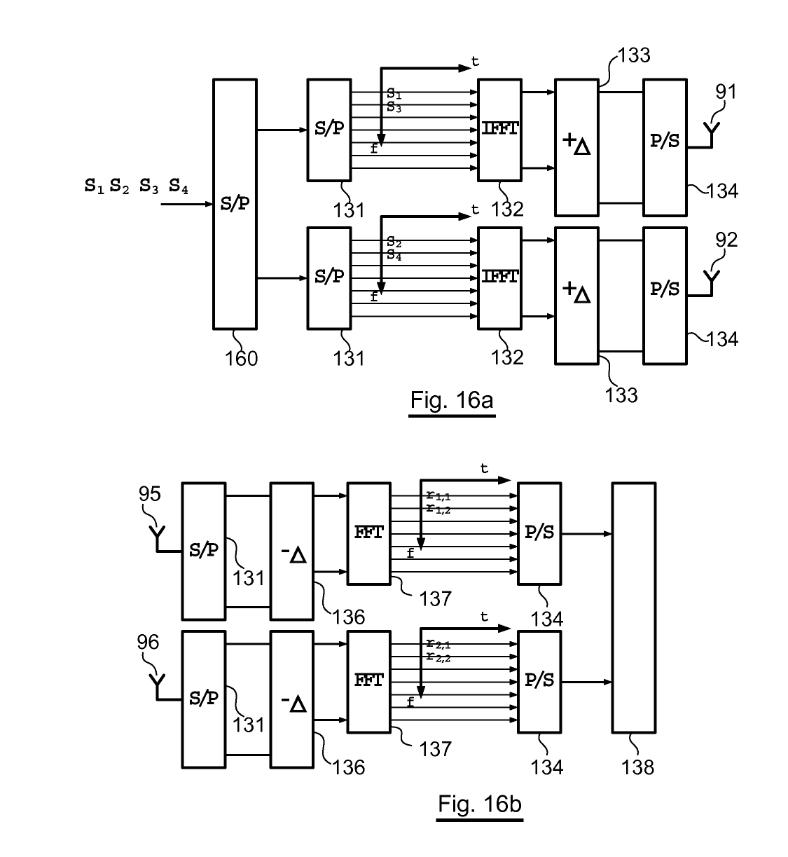

FIGS. 16a and 16b illustrate the principle of OFDM modulation/demodulation at transmission and reception in this context. These figures consider the case of a MIMO scheme with two transmit antennas 91, 92 and two receive antennas 95, 96 in the context of use of a space multiplexing technique. The size of the linear pre-encoding is Lp=4.

In FIG. 16a, the symbols s₁, s₂, s₃ and s₄ of the linearly pre-encoded M-ary signal undergo a first series/parallel conversion S/P 160, and are then distributed on two processing channels. On the first channel, the symbols s₁ and s₃ are distributed in the time-frequency plane t-f, while the second processing channel distributes the symbols s₂ and s₄ in the plane t-f. Each of the two processing channels is identical to the scheme of FIG. 13a and shall therefore not be described here in greater detail.

At reception, the signals received at each of the two antennas 95, 96 undergo processing identical to that of FIG. 13b. The received vector r, which is fed into the iterative receiver 138, has the form:

$$r = [ \begin{matrix}{r}_{1 , 1} \\ {r}_{2 , 1} \\ {r}_{1 , 2} \\ {r}_{2 , 2}\end{matrix} ]$$

where the symbols r_{1, 1} and r_{1, 2} come from the processing channel coming from the first receive antenna 95 and where the symbols r_{2, 1} and r_{2, 2} come from the processing channel coming from the second receive antenna 96.

As described here above in the case of the SISO, it is also possible at transmission to arbitrarily distribute the pre-encoding symbols in time and in frequency (“map F/T”). The dual operation (“demap F/T”) must then be performed at reception on each antenna 95, 96 upstream from the iterative receiver 138.

Appendix 1 here below, which forms an integral part of the present description, proposes a detailed demonstration of the computation of the coefficients of the interference canceller of the receiver of the invention.

The iterative receiver of the invention has wholly satisfactory performance and can be used especially for efficient estimation of the signal sent in the presence of major interference, whether this interference results from extensive linear pre-encoding, from the use of a BLAST system (Bell Laboratories Layered Space-Time, also called a MIMO system) with several antennas, or again from non orthogonal space-time encoding.

APPENDIX 1: Demonstration of the Computation of the Coefficients of the Interference Canceller

We may recall the expression of the signal at input of the receiver:

r=C(eₖxₖ+aₖ)+n (1)

Where eₖ is a null vector whose kith element is equal to 1 and âₖ=x−xₖeₖ. At output of the interference canceller we get

\hat{x}ₖ=Pₖ^{H}r−qₖ^{H}âₖ (2)

Where p and q are two filtering vectors. The following problem has to be resolved:

$$( {p}_{k}^{opt} , {q}_{k}^{opt} ) = arg {min}_{P , Q} ɛ [ {‖ {x}_{k} - {x}_{k}^{\%} ‖}^{2} ] \qquad ( 3 )$$

The optimum vectors pₖ^{H} and qₖ^{H} are determined in two steps. First of all, we develop the expression of the signal-to-interference noise ratio (SNIR). Let us rewrite the expression \hat{x}ₖ as a function of xₖ.

$${\tilde{x}}_{k} = \begin{matrix}{P}_{k}^{H} {Ce}_{k} {x}_{k} & + & {p}_{k}^{H} {Ca}_{k} - {q}_{k}^{H} {a}_{k} & + & {p}_{k}^{H} n \\ 14243 & & 1442443 & & \{ \\ useful term & & interfering terms & & noise term\end{matrix} \qquad ( 4 )$$

The SNIR is equal to:

$$SNIR = \frac{ɛ [ {p}_{k}^{H} {Ce}_{k} {e}_{k}^{H} {C}^{H} {p}_{k} ] {σ}_{x}^{2}}{ɛ [ \begin{matrix}( {p}_{k}^{H} {Ca}_{k} - {q}_{k}^{H} {\hat{a}}_{k} + {p}_{k}^{H} n ) \\ {( {p}_{k}^{H} {Ca}_{k} - {q}_{k}^{H} {\hat{a}}_{k} + {p}_{k}^{H} n )}^{H}\end{matrix} ]} = \frac{{σ}_{U}^{2}}{{σ}_{NI}^{2}} \qquad ( 5 )$$

We propose to determine the optimum filters which maximize SNIR at output of the equalizer. Since the SNIR maximization criterion is a generalization of the MMSE, the vectors obtained truly meet the MMSE criterion. In looking at the expression of the SNIR it can be seen that only the numerator depends on qₖ. Thus, the optimum vector qₖ^{opt} can be determined by minimizing the σ_{NI}². In deriving relative to qₖ we obtain:

$$\frac{\partial {σ}_{NI}^{2}}{\partial {q}_{k}} = ɛ [ {\hat{a}}_{k} {a}_{k}^{H} ] {C}^{H} {p}_{k} + ɛ [ {\hat{a}}_{k} {n}^{H} ] {p}_{k} - ɛ [ {\hat{a}}_{k} {\hat{a}}_{k}^{H} ] {q}_{k} \qquad ( 6 )$$

On the one hand, we consider a perfect decorrelation between the symbols and the noise and, secondly, it is assumed that

$$\frac{ɛ [ {\hat{a}}_{k} {a}_{k}^{H} ]}{ɛ [ {\hat{a}}_{k} {\hat{a}}_{k}^{H} ]} \approx 0.$$

In setting

$$\frac{\partial {σ}_{NI}^{2}}{\partial {q}_{k}} = 0 ,$$

we obtain the optimal first vector:

qₖ^{opt}=IₖC^{H}pₖ (7)

Where Iₖ=I−eₖeₖ^{H}εC^{L×L} and I is the identity matrix sized L×L. Let us now rewrite the expression of the equalized signal:

$$\begin{matrix}{\tilde{x}}_{k} = {p}_{k}^{H} r - {I}_{k} {p}_{k} {Ca}_{k} \\ = {p}_{k}^{H} r - {p}_{k} {Ca}_{k} \\ = {p}_{k}^{H} ( r - {Ca}_{k} )\end{matrix} \qquad ( 8 )$$

The new expression of the mean square-root error (MSE) is equal to:

$${g}_{k}^{2} {=}^{Δ} ɛ [ ( {x}_{k} - {p}_{k} ( r - C {\hat{a}}_{k} ) ) {( {x}_{k} - {p}_{k}^{H} ( r - C {\hat{a}}_{k} ) )}^{H} ] \qquad ( 9 )$$

Let us derive this expression relative to pₖ:

$$\frac{\partial {ɛ}_{k}^{2}}{\partial {p}_{k}} = {ɛ [ ( r - C {\hat{a}}_{k} ) {( r - C {\hat{a}}_{k} )}^{H} ] {p}_{k}}_{{1 \; 4 \; 4 \; 4 \; 4 \; 4 \; 2 \; 4 \; 4 \; 4 \; 4 \; 4 \; 3}_{R}} - {ɛ [ ( r - C {\hat{a}}_{k} ) {x}_{k}^{*} ]}_{{1 \; 4 \; 4 \; 2 \; 4 \; 4 \; 3}_{P}} \qquad ( 10 )$$

In setting

$$\frac{\partial {ɛ}_{k}^{2}}{\partial {p}_{k}} = 0 ,$$

we obtain:

pₖ^{opt}=R⁻¹P (11)

In considering a perfect decorrelation between two symbols, we have:

$$\begin{matrix}ℛ = C ɛ [ ( x - {a}_{k} ) \cdot {( x - {a}_{k} )}^{H} ] {C}^{H} + ɛ [ {nn}^{H} ] \\ = C {V}_{k} {C}^{H} + {σ}_{n}^{2} I\end{matrix} \qquad ( 12 )$$

Where V ₖ=diag[σᵣ²−σᵣ² , . . . , σₓ², . . . , σₓ², . . . , σₓ²−σₓ²]εC^{L×L} (which is actually the matrix of covariance of x-x in which the kith element of the diagonal has been

$${σ}_{x}^{2} \qquad {σ}_{x}^{2} )$$

is the variance of the estimated symbols. Furthermore we have:

$$𝒫 = C ɛ [ {xx}_{k}^{*} ] = {σ}_{x}^{2} {Ce}_{k}$$

(13)
Thus the final expression of the optimal vector is:

$${p}_{k}^{opt} = {{σ}_{x}^{2} ( C {V}_{k} {C}^{H} + {σ}_{n}^{2} I )}^{- 1} {Ce}_{k} \qquad ( 14 )$$

It is noted that a matrix inversion

$$\frac{{N}_{r} TL}{K} \times \frac{{N}_{r} TL}{K}$$

sized is necessary for each equalized symbol.
Let us rewrite the expression of

$${p}_{k}^{opt} \text{:}$$

pₖ^{opt}=σᵣ²(C[(σₓ²−σₓ²)I+σₓ²eₖeₖ^{H}]C^{H}+σₙ²I)⁻¹Cₖeₖ (15)

Using the Sherman-Morrison-Woodbury identity (A+uv^{H})⁻¹=

$${A}^{- 1} - \frac{{A}^{- 1} {uv}^{H} {A}^{- 1}}{1 + {v}^{H} {A}^{- 1} u} ,$$

the last equation becomes:

$${p}_{k}^{opt} = [ \frac{1}{1 + {σ}_{\hat{x}}^{2} {e}_{k}^{H} {H}^{H} {\overline{p}}_{k}^{opt}} ] {\overline{p}}_{k}^{opt} \qquad ( 16 )$$

### Where

\tilde{p}ₖ^{opt}=σₓ²(CC^{H}(σₓ²−σₓ²)+σₙ²I)⁻¹Ceₖ (17)

Only a matrix inversion (always sized

$$\frac{{N}_{r} TL}{K} \times \frac{{N}_{r} TL}{K} )$$

is necessary for a block of L symbols. Now is \tilde{p}ₗ^{opt} simply proportional to pₖ^{opt}. It is therefore possible to use the expression of \tilde{p}ₖ^{opt}. In matrix notation, we finally obtain.

$$\begin{matrix}{P}^{H} = {( {C}^{H} C [ \frac{{σ}_{x}^{2} - {σ}_{x}^{2}}{{σ}_{x}^{2}} ] + {σ}_{n}^{2} I )}^{- 1} {C}^{H} and & ( 18 ) \\ {Q}^{H} = ddiag ( {P}^{H} C ) & ( 19 )\end{matrix}$$

Where the operator stores n ddding (A) coefficients of A in a matrix of equivalent size.

What is claimed is:

1. Method of reception of a multiple-carrier data signal, called a multi-carrier signal, having undergone channel encoding at transmission,
said method employing an estimation of the received signal, delivering an estimated signal,
characterized in that it comprises at least one iteration of improvement of said estimated signal as a function of said received signal and of a preceding estimated signal,
and in that said at least one iteration comprises, for each of said carriers of said received signal, a step of equalization of said carrier by cancellation of an interference affecting said received carrier, as a function of at least one statistical parameter of said previous estimated signal.

2. Method of reception according to claim 1, characterized in that said iteration comprises the following steps for each of said carriers:
filtering of said received carrier, delivering a filtered carrier;
determining an interference that affects said received carrier, generated at transmission of said multi-carrier signal and/or due to the transmission channel of said multi-carrier signal, said determining step delivering an estimated interference;
subtraction of said estimated interference from said filtered carrier so as to obtain an improved carrier;
equalization of said improved carrier, delivering an equalized carrier;
estimation, from at least said equalized carrier, of the sent carrier, delivering an estimated carrier,
and in that said estimated signal takes account of each of said estimated carriers.

3. Method of reception according to claim 2, characterized in that said filtering step applies a multiplication of a vector representing said carrier received by a filtering matrix taking account of at least one matrix representing said transmission channel, of a signal-to-noise ratio and of said statistical parameter.

4. Method of reception according to any of the claims 2 and 3, characterized in that said step for determining interference employs a multiplication of a vector representing said previous estimated carrier by an interference matrix taking account of at least said matrix representing said transmission channel and said statistical parameter.

5. Method of reception according to any one of the claims 1 to 4, characterized in that said statistical parameter is the variance of said preceding estimation of said received signal.

6. Method of reception according to any one of the claims 1 to 5, characterized in that said preceding estimation is delivered by the preceding iteration for all the iterations except the first one, and is delivered by a step of preliminary estimation for the first iteration.

7. Method of reception according to any one of the claims 4 to 6, characterized in that said multi-carrier signal undergoes a linear pre-encoding at transmission by multiplication by a pre-encoding matrix, and in that said filtering and interference matrices also take account of said pre-encoding matrix.

8. Method of reception according to any one of the claims 1 to 7, characterized in that said multi-carrier signal undergoes space-time encoding at transmission and is transmitted by and/or received on at least two antennas.

9. Receiver of a multiple-carrier data signal, called a multi-carrier signal, having undergone channel encoding at transmission,
said receiver comprising means of estimation of the received signal, delivering an estimated signal,
characterized in that it comprises means of improvement of said estimated signal, as a function of said received signal and of a preceding estimated signal, implementing at least once, in the form of an iteration, and for each of said carriers of said received signal, means of equalization of said carrier by cancellation of an interference affecting said received carrier, as a function of at least one statistical parameter of said previous estimated signal.

10. Computer program product comprising program code instructions for the execution of the steps of the method of reception of a multiple-carrier data signal according to any one of the claims 1 to 8, when said program is executed in or by a microprocessor.
